(19) United States
(12) Patent Application Publication
(10) Pub. No.: US 2026/0175348 A1
(43) Pub. Date: Jun. 25, 2026

(54) REVERSIBLE FLANGE ASSEMBLY FOR POWER TOOLS

(71) Applicant: Black & Decker Inc., New Britain, CT (US)

(72) Inventors: Joseph Malcolm Palmer, Columbia, MD (US); Earnest N. Copeland, JR., White Marsh, MD (US); Sepehr Keshavarz Motamedi, Gaithersburg, MD (US); Floyd Eugene Moreland, IV, York, PA (US); Joseph Arthur Steele, Baltimore, MD (US); Philip Brooks Bolton, Towson, MD (US)

(21) Appl. No.: 18/999,302

(22) Filed: Dec. 23, 2024

(51) Int. Cl. B24B 23/02; B25F 5/00

(52) U.S. Cl. CPC B24B 23/02; B25F 5/001

(57) ABSTRACT

A clip-on guard assembly for a tool guard is disclosed. The tool guard provides shielding for a tool, and the clip-on guard assembly can be detachably mounted to the tool guard to provide additional shielding coverage for the tool. The clip-on guard assembly can include a guard cover that provides shielding coverage, first and second fasteners disposed on opposite ends of the guard cover, a lever pivotably mounted to the guard cover, and a locking member configured to releasably lock the lever in place when the guard is in use. In operation, the first fastener can be fitted onto one end of the tool guard. Pivoting the lever can move the second fastener into engagement with the opposite end of the tool guard, allowing an operator to securely attach the guard cover to the tool guard, thereby providing modified shielding coverage for the tool. Pivoting the lever in the opposite direction can move the second fastener away, allowing the clip-on guard assembly to be detached from the tool guard.

### FIELD

The present disclosure generally relates to flange assemblies for power tools and, more particularly, to reversible flange systems configured for use with various dynamic working tools having different mounting aperture sizes.

### BACKGROUND

Flange assemblies can be used in power tools to secure and stabilize dynamic working tools such as cutting or grinding discs during operation. These assemblies can ensure proper engagement and rotational stability of the working tool. Different working tools can require specific flange configurations based on factors such as aperture size, thickness, or the type of operation being performed. Managing compatibility between multiple tool sizes or types can involve the use of multiple flange sets, which may increase setup time and the possibility of misplaced or incompatible components.

### BRIEF DESCRIPTION OF THE DRAWINGS

Throughout the drawings, reference numbers can be re-used to indicate correspondence between referenced elements. The drawings are provided to illustrate embodiments of the present disclosure and do not limit the scope thereof.

FIG. 1 illustrates a side view of a power tool in accordance with the present disclosure.

FIGS. 2A-2D illustrate various configurations of a dynamic working tool retention mechanism, including a reversible retention flange and a transfer component in different assembly positions.

FIG. 3 illustrates a partial exploded view of a power tool.

FIGS. 4A and 4B depict two surfaces of a reversible retention flange, with each surface configured to selectively engage a particular type of dynamic working tool and the transfer component, but only one at a time.

FIG. 4C illustrates a side profile view of an example reversible retention flange.

FIG. 5 illustrates a detailed view of the engagement interfaces of the transfer component.

FIGS. 6A and 6B illustrate example outer flanges, each designed to secure a tool engagement assembly in place by threading onto the output spindle.

FIGS. 7A-7C illustrate various stages of assembly for a power tool using a first dynamic working tool and the associated retention flanges.

FIGS. 8A-8C illustrate various stages of assembly for a power tool using a second dynamic working tool and the associated retention flanges.

FIGS. 9A and 9B illustrate an on-tool storage configuration for a presently unused outer flange.

### DETAILED DESCRIPTION

Although certain embodiments and examples are described below, it will be understood that the disclosure extends beyond the specifically disclosed embodiments and/or uses and obvious modifications and equivalents thereof. Thus, it is intended that the scope of the disclosure herein disclosed should not be limited by any particular embodiments described below.

Flange assemblies for power tools, particularly grinders, can be configured to accommodate dynamic working tools with different arbor sizes. Traditionally, these tools require separate flange sets for each arbor size, resulting in potential inconvenience and increased setup time for users. Managing multiple flange sets can be burdensome, with the risk of misplacement or incompatibility.

Some inventive concepts described herein relate to a reversible retention flange. The reversible retention flange can be configured to engage dynamic working tools with varying arbor sizes, allowing operators to use accessories of different sizes (e.g., ⅜-inch, 7/16-inch, ½-inch, or ⅝-inch accessories) with a single flange. This reversible design can reduce or eliminate the need for multiple flange sets, enabling quicker adjustments with fewer tools to accommodate different accessory sizes. In some cases, the reversible retention flange can advantageously enhance the versatility of power tools.

Some inventive concepts described herein can relate to the structural features of the reversible retention flange and its engagement with dynamic working tools. For example, the reversible retention flange can include first and second engagement interfaces, each designed to engage a dynamic working tool or transfer component. In operation, the first engagement interface can engage a dynamic working tool with a first arbor size or the transfer component, while the second engagement interface can engage a dynamic working tool with a different arbor size.

The reversible retention flange described herein can be designed to fit a variety of power tools, including, but not limited to, grinders, cutting tools, or polishing devices. By providing a solution that combines the functionality of multiple flanges into one, the inventive concepts described herein can improve the practicality and efficiency of power tool operation, allowing operators to manage flange configurations more effectively.

Some inventive concepts described herein can provide an advancement in the field of power tool attachments, for example by simplifying flange management across different arbor sizes. By enabling quick adaptation between arbor sizes, the disclosed reversible retention flange can enhance the versatility and user experience of power tools in diverse applications.

Some inventive concepts described herein relate to a transfer component. The transfer component can include a plurality of engagement interfaces, each configured to interact with either different retention flanges with distinct engagement features or with opposing sides of a reversible retention flange. In operation, one side of the transfer component can include multiple engagement interfaces, each capable of engaging a specific retention flange or one side of a reversible retention flange. In some cases, the transfer component can have three, four, or more engagement interfaces on one side, facilitating secure rotational transfer across a range of configurations.

### Example Power Tool

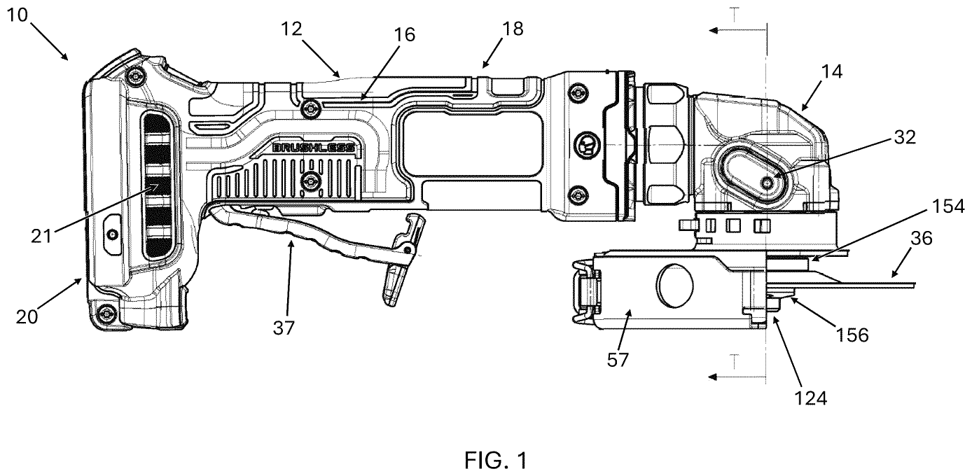

FIG. 1 illustrates a side view of a power tool in accordance with the present disclosure. The power tool 10 can include a housing 12 having a gear case 14, a motor case 16, handle portions 18, 21, and a battery receiver 20 for a battery (not shown). The power tool 10, as shown, is a grinder with the gear case 14 housing a gearset (not shown) that drives an output spindle 124 arranged to be coupled to a dynamic working tool 36, such as a grinding disc, a cutting disc, or an accessory wheel, either via threads on the dynamic working tool 36, or via an outer flange 56 (or threaded nut) and guarded by a disc guard 57. The power tool 10 can also include a paddle switch 37 arranged for user actuation, and a spindle lock button 32 for securing the output spindle 124 during tool change. A detailed example of the power tool 10 may be found in PCT Application No. PCT/US24/60792 filed Dec. 18, 2024, which hereby is incorporated herein by reference in its entirety.

Although illustrated as a grinder, it will be appreciated that the power tool 10 need not be limited to such a device. For example, the power tool 10 can include, but is not limited to, saws, drills, sanders, or other grinders. The gearset can include the output spindle at a 90-degree angle orientation or in a linear orientation. The gear case 14 can include an upper gear case cover and a lower gear case cover that cooperatively house the gearset components.

The motor case 16 can house a motor operatively connected to the gearset. An intermediary plate or baffle can be disposed between the motor case 16 and the rear end of the gear case 14. The motor can be a brushless direct-current (BLDC) motor having a stator and a rotor rotatable relative to the stator. The rotor can be mounted on a rotor shaft that rotatably drives the output spindle via the gearset. A fan can be mounted on the rotor shaft between the motor and the gear case 14, facing the intermediary plate or baffle, to generate airflow for cooling the motor and other components. The airflow generated by the fan can exit through an air exhaust vent provided on the motor case 16 and/or the gear case 14.

The housing 12 can include a paddle switch 37 operatively connected to a switch assembly. The switch assembly can be operatively coupled to a control module and/or a power module, which can be located within the handle portion 21. The control module can include a programmable controller and can control a switching operation of the power module. The power module can be a circuit board including a series of Field-Effect Transistors (FETs) interconnected as a multi-phase inverter circuit for powering the phases of the motor. The control module, switch assembly, and power module can be provided discretely or integrated into sub-assemblies. In some cases, the control module is disposed at a rear of the handle portion 21 adjacent to the battery receiver 20. The battery receiver 20 can be provided at the rear end of the power tool 10 for detachable engagement with a battery pack (not shown) to provide power to the motor.

The battery pack 21 can be a 20-volt max lithium-ion type battery pack (not shown), although battery packs with other battery chemistries, shapes, voltage levels, etc., can be used in other embodiments. The battery receiver 20 and battery pack can be a sliding pack as disclosed in U.S. Pat. No. 8,573,324, hereby incorporated by reference. However, any suitable battery receiver and battery back configuration, such as a tower pack or a convertible 20V/60V battery pack as disclosed in U.S. Pat. No. 9,406,915, patented Aug. 2, 2016, hereby incorporated by reference, can be used. The embodiment of FIG. 1 shows a cordless, battery-powered tool. However, in alternate embodiments, the power tool 10 can be corded, AC-powered tools. For instance, in place of the battery receiver 20 and battery pack, the power tool 10 can include an AC power cord coupled to a transformer block to condition and transform the AC power for use by the components of the power tools. The power tool 10 can, for example, include a rectifier circuit adapted to generate a positive current waveform from the AC power line. An example of such a tool and circuit can be found in US Patent Publication No. 2015/0111480, filed Oct. 18, 2013, which is incorporated herein by reference in its entirety.

The control module can use the input from the switch assembly to set a target speed for the motor. This can be done by controlling a pulse-width modulation (PWM) of the power switches within the power module. When the paddle switch 37 is released, the control module can activate the low-side switches or the high-side switches of the power module simultaneously for regenerative electronic braking of the motor. A description of the power and control modules and electronic braking of the motor can be found in US Patent Publication No. 2017/0234484, filed Feb. 10, 2017, which is incorporated herein by reference in its entirety.

Braking of the motor at high speed, either electronically or via a mechanical brake, can cause rapid deceleration of the output spindle. Absent a mechanism to retain and protect the dynamic working tool 36, high inertia of the dynamic working tool 36 can cause it to detach from the output spindle upon rapid deceleration. In some configurations, the outer flange 56 can be provided with a spring mechanism to apply an upward force on the dynamic working tool 36 to increase friction between the dynamic working tool 36 and an upper flange of the power tool 10, as well as the friction between the threads of the outer flange 56 and output spindle 124. Additionally, and/or alternatively, in some configurations, the power tool 10 can be provided with a wheel retention mechanism configured to apply a downward force on the dynamic working tool 36 to similarly increase the friction between the dynamic working tool 36 and the upper flange of the power tool 10, as well as the friction between the threads of the outer flange 56 and the output spindle 124, resulting in an increased unseating torque over a range of thread travel. This increased friction can significantly reduce the likelihood of the dynamic working tool 36 coming off the output spindle.

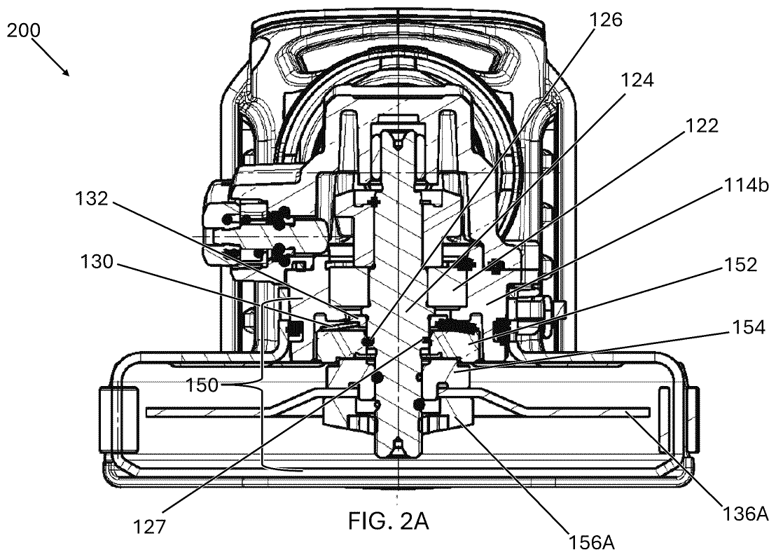

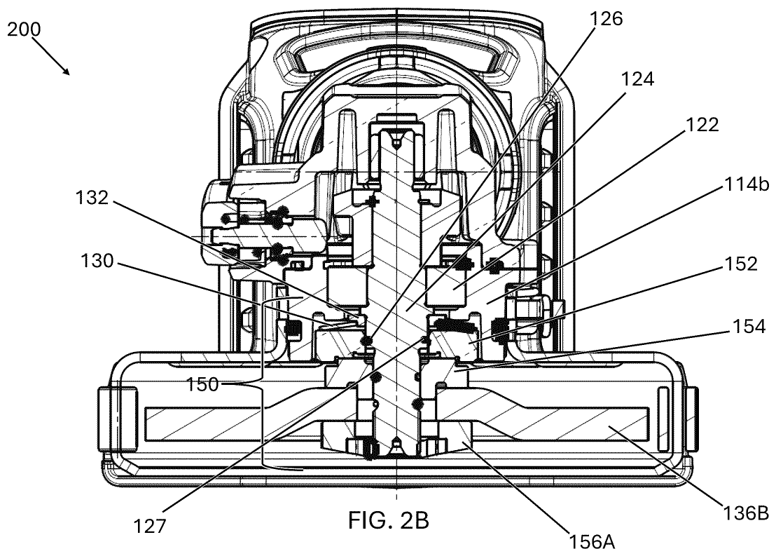

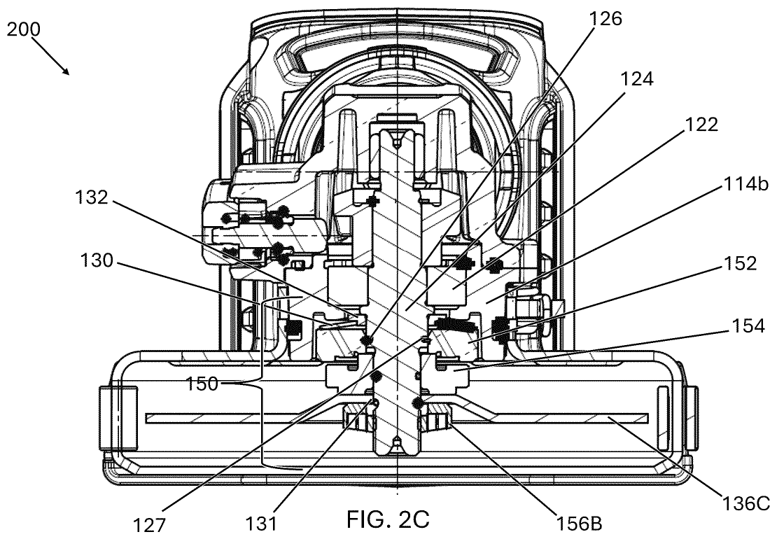

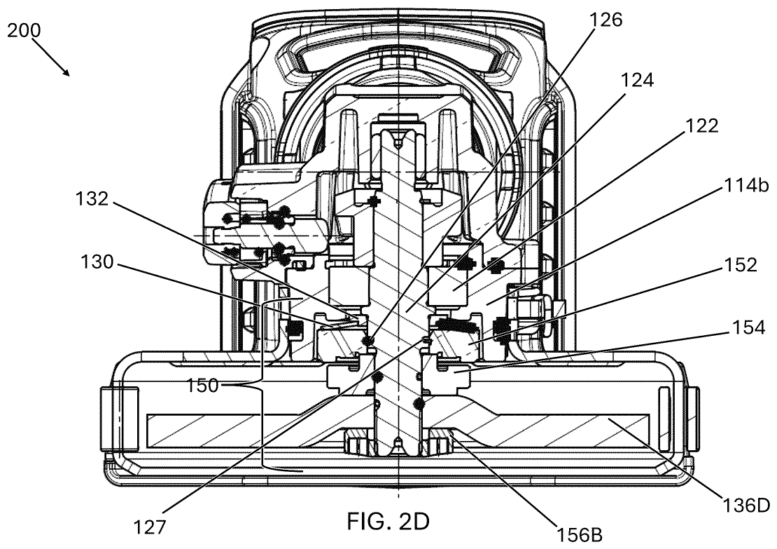

FIGS. 2A-2D illustrate side cross-sectional views of a portion of a power tool 200 that includes a reversible retention flange 154 and dynamic working tools 136A, 136B, 136C, 136D (individually or collectively referred to as “dynamic working tool 136”) with varying thicknesses or mounting apertures. FIGS. 2A and 2B show the reversible retention flange 154 in a first orientation, where the dynamic working tools 136A, 136B have the same first-sized mounting aperture, with FIG. 2B illustrating a dynamic working tool 136B with a thicker profile compared to the dynamic working tool 136A shown in FIG. 2A. FIGS. 2C and 2D illustrate the reversible retention flange 154 in a second, flipped orientation relative to the first orientation, where the dynamic working tools 136C, 136D have the same second-sized mounting aperture, with FIG. 2D illustrating the dynamic working tool 136C with a thicker profile compared to the dynamic working tool 136D shown in FIG. 2C. FIG. 2C further illustrates a spindle radial engagement interface 131 configured for dynamic working tools with a ⅜ of an inch diameter arbor.

FIGS. 2A-2D show a lower gear case cover 114b, an output spindle 124, and a tool engagement assembly 150, and a dynamic working tool 136. The tool engagement assembly 150 includes a transfer component 152, a reversible retention flange 154, and an outer flange 156A, 156B (individually or collectively referred to as “outer flange 156”).

The output spindle 124 can extend from the lower gear case cover 114b and can be rotatably driven by an electric motor housed within the power tool. The output spindle 124 can be supported by a bearing 122, which can provide axial stability and allow the output spindle to rotate freely within the gear case. The output spindle can have a threaded portion at one end, configured to engage with various dynamic working tools, allowing them to be mounted securely for rotational operation.

The transfer component 152 can be positioned along the output spindle 124. For example, the transfer component 152 can include a pass-through aperture through which the output spindle 124 extends. The transfer component 152 is axially constrained and held in place by frictional forces and the force exerted by the spring member 130 (e.g., a Belleville disc) positioned between the transfer member 128 and the bearing 122 (e.g., via a spacer 132). The transfer member 128 moves relative to the output spindle 124 based on the forces applied by the dynamic working tool when tightened or loosened. As shown in the illustrated embodiments of FIGS. 2A-2B, the transfer component 152 can be axially constrained relative to the output spindle 124 via a retention clip 126, where a retention clip 126 is seated within an annular recess 127 in the output spindle 124 and also seated within a corresponding recess 129 in the transfer component 152. As another example, the transfer component 152 can be axially constrained relative to the output spindle 124 via an annular shoulder formed by a radial projection on transfer component 152 and/or the output spindle 124, for example, as described in U.S. Pat. Publication No. 2022/0063047, published Mar. 3, 2022, entitled “Retention Flange For Power Tool, which is hereby incorporated by reference in its entirety.” The axial constraint of the transfer component 152 relative to the output spindle 124 can facilitate proper alignment and stability during operation of the power tool 200, or tightening or loosening of the dynamic working tool 136.

The reversible retention flange 154 can be engageable with the transfer component 152 and can include a pass-through aperture that allows the output spindle 124 to extend through it. The reversible retention flange 154 can have opposing first and second faces, each equipped with distinct engagement interfaces. The first face of the reversible retention flange 154 can be configured to selectively engage, one at a time, a dynamic working tool 136A, 136B with a first-sized mounting aperture (e.g., a ⅜ inch arbor) or the transfer component 152. This first engagement interface can include raised or recessed features that align with the mounting aperture of the dynamic working tool 136A, 136B and, in the alternative, the transfer component 152, facilitating effective rotational engagement between whichever is selected.

Similarly, the second face of the reversible retention flange 154 can be configured to engage, one at a time, a second dynamic working tool 136C, 136D with a second-sized mounting aperture (e.g., a ⅝ inch arbor). This second engagement interface can include raised or recessed features that correspond with the mounting aperture of the dynamic working tool 136C, 136D, and, in the alternative, the transfer component 152, ensuring secure rotational engagement between whichever is selected. The reversible nature of the reversible retention flange 154, combined with the capacity of the transfer component 152 to engage with either face of the reversible retention flange 154, improves versatility in tool attachment. For example, in some cases, such a design allows the same reversible retention flange 154 to be used to accommodate dynamic working tools with different mounting aperture sizes, such as those with ⅜ inch or ⅝ inch arbors.

The outer flange 156A can be positioned at the lower end of the output spindle 124, threaded onto the output spindle to secure the tool engagement assembly 150 in place. The tool engagement assembly 150 is arranged such that the output spindle 124 extends through the transfer component 152, followed by the reversible retention flange 154, the selected dynamic working tool 136, and finally the appropriately sized outer flange 156A, 156B. Since the reversible retention flange 154 can accommodate arbors and clamping surfaces of different size diameters, multiple outer flanges 156A, 156B may be employed, with each outer flange corresponding to a specific arbor and clamping surface size diameters supported by the reversible retention flange 154.

When the dynamic working tool 136A is mounted on the output spindle 124, the rotational force of the dynamic working tool 136A as it is tightened can impart an upward force on the reversible retention flange 154 and the transfer component 152 through the outer flange 156A, 156B. This upward movement of the transfer component 152 can occur against the force of the spring member 130. The spring member 130 can apply a downward force, which increases the friction between the transfer component 152, the reversible retention flange 154, the outer flange 156A, and the dynamic working tool 136, and the outer flange threads and spindle threads, collectively providing axial clamping force between components to secure the dynamic working tool 136 in place during operation.

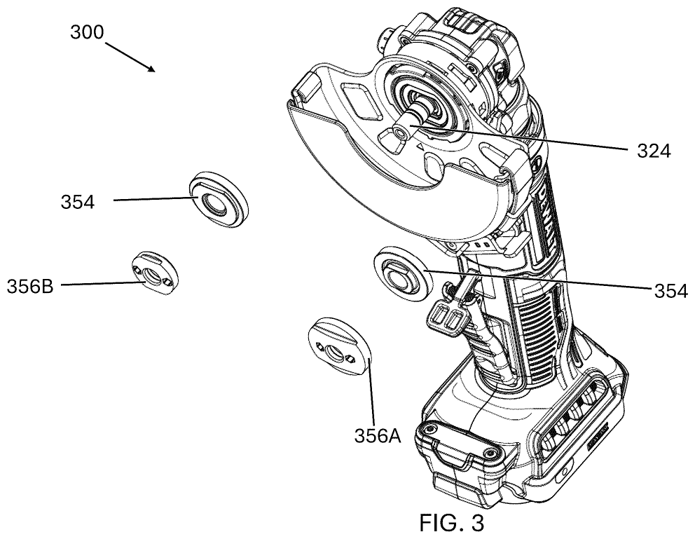

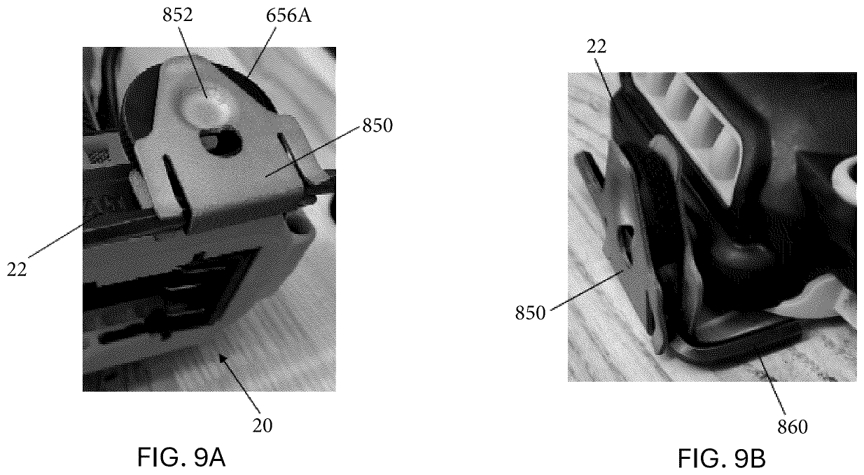

FIG. 3 illustrates a partial exploded view of a power tool 300, showing a power tool 300 with an output spindle 324. FIG. 3 further illustrates a reversible retention flange 354 in two orientations: a first orientation and a second, flipped orientation. Each orientation of the reversible retention flange 354 is shown with its corresponding outer flange, 356A and 356B, respectively. In this example, the first outer flange 356A is compatible with a first arbor size (e.g., Ø⅝″), while the second outer flange 356B corresponds to a second arbor size (e.g., Ø⅜″). These configurations demonstrate how the reversible retention flange 354 can accommodate dynamic working tools with different arbor sizes by flipping its orientation and using the appropriate outer flange. In some cases, a ⅜-inch arbor accessory engages radially with the ˜⅜-inch spindle directly, while a ⅝-inch arbor accessory engages radially with the reversible retention flange 354, and the reversible retention flange 354, in turn, engages radially with the output spindle 324. In this example, no dynamic working tool is shown installed. Each outer flange secures dynamic working tools according to the arbor size of the face of the reversible retention flange 354 being used, ensuring proper engagement and stability during operation. In some cases, such as described with respect to FIGS. 9A and 9B, the power tool 300 may include a storage compartment for storing a presently unused outer flange, allowing for convenient on-tool storage when switching between arbor sizes.

### Example Reversible Retention Flange

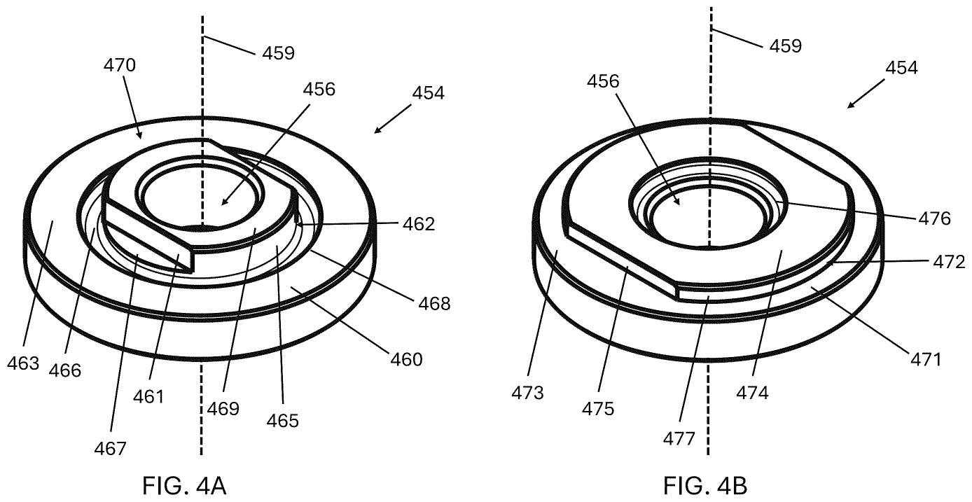

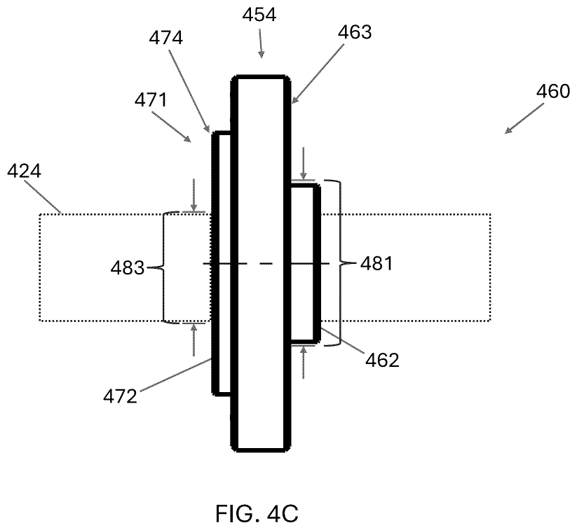

FIGS. 4A and 4B depict two surfaces of a reversible retention flange 454, with each surface configured to selectively engage a particular type of dynamic working tool and the transfer component 152, but only one at a time. The protrusion 462 defines a central pass-through aperture 456, which accommodates an output spindle of a power tool. Consequently, the reversible nature of the reversible retention flange 454, with either side having the capacity to engage with both the transfer component 152 and a dynamic working tool, allows for versatility in use. A user can flip the reversible retention flange 454 to engage dynamic working tools with different arbor sizes (e.g., ⅜″ or ⅝″), depending on the tool requirements. This selective engagement with either the dynamic working tool or the transfer component provides secure rotational fixation and proper alignment during operation.

FIG. 4A illustrates the first side 460 of the reversible retention flange 454. The first side 460 includes a substantially flat first surface 463 (sometimes referred to as axial clamping surface 463) that extends radially outward from a central axis 459, which is defined by the central pass-through aperture 456. The central pass-through aperture 456 is configured to accommodate the output spindle of a power tool, and the central axis 459 extends longitudinally along the output spindle's path.

The first side 460 includes a protrusion 462 that extends upward from a central region of the first side 460. The protrusion 462 may be concentrically aligned with the central axis 459 and forms an engagement interface 470. The protrusion 462 has a generally cylindrical profile and includes flat surfaces 461 positioned on opposite sides of the cylindrical wall 465. The top surface 469 of the protrusion 462 can be flat and transition smoothly into the central pass-through aperture 456 via a curved or tapered connection. The flat surfaces 461 may allow the engagement interface 470 to engage selectively with complementary engagement interfaces on either a transfer component or a dynamic working tool having a mounting aperture of a first size. The first side 460 further includes a flat section 467 positioned where the cylindrical wall of the protrusion 462 would extend if not interrupted by the flat surfaces 461. The flat surface 461 can rotatably lock the reversible retention flange 454 to a transfer component. The transfer component can include similar flat surfaces that engage with flat surfaces on the output spindle, rotatably locking the two together. Subsequently the reversible retention flange is rotatably locked to the output spindle through the retention component.

The first side 460 includes a recess 466 that is positioned concentrically around the exterior of the protrusion 462. The recess 466 is formed between the outer perimeter of the protrusion 462 and the first surface 463. The concentric placement of the recess 466 can follow the contour of the protrusion 462, creating an annular gap or depression that lies adjacent to the outer cylindrical wall 465 of the protrusion 462. The recess 466 may allow clearance for specific components of the dynamic working tool or a transfer component when they are engaged with the first side 460 of the reversible retention flange 454.

The first surface 463 lies in a plane that is substantially perpendicular to the central axis 459 and extends radially outward from the base of the protrusion 462 and the recess 466. The first surface 463 is positioned concentrically around the exterior of the recess 466 and transitions into a raised surface relative to the recess 466, forming a step 468 between the outer perimeter of the recess 466 and the inner perimeter of the first surface 463. The outer perimeter of the first surface 463 can include an outer lip, located along the periphery of the first side 460. This surface 463 can axially constrain the dynamic working tool and provide clamping force, and subsequently friction, to retain the dynamic working tool in operation. In some cases, the axial clamping surface 463 can interface with the dynamic working tool.

The second side 471 of the reversible retention flange 454 includes a protrusion 472 that extends upward from a central region of the second side 471. The protrusion 472 is concentrically aligned with the central axis 459 and forms a second engagement interface. The protrusion 472 has a generally cylindrical profile and includes flat surfaces 475 positioned on opposite sides of the cylindrical wall 477. The top surface 474 (sometimes referred to as axial clamping surface 474) of the protrusion 472 is flat and transitions into the central pass-through aperture 456, which is an extension of the recess 476. The flat edges 475 of the protrusion 472 may facilitate engage with complementary engagement interfaces on a transfer component. In some cases, this flat surface geometry of the reversible retention flange 454 can be used for engagement with the transfer component to rotatably lock it to the spindle, while the axial clamping surface 474 can interface with the dynamic working tool. In some cases, the radial interface for the ⅜-inch dynamic working tool can be directly with the ⅜-inch diameter spindle.

The second side 471 further includes a relatively flat second surface 473. The second surface 473 lies in a plane substantially perpendicular to the central axis 459 and extends radially outward from the base of the protrusion 472. The second surface 473 is positioned concentrically around the exterior of the protrusion 472, forming a step down between the outer perimeter of the protrusion 472 and the inner perimeter of the second surface 473. The second surface 473 may include an outer lip along the periphery of the second side 471. In some cases, the second surface 473 may serve as a clearance surface and may not provide functional engagement with other features or components.

FIG. 4C illustrates a side profile view of an example reversible retention flange 454, showing the relative thicknesses and heights of the protrusions 462, 472 extending from the first side 460 (on the right) and the second side 471 (on the left), respectively. In this example, the protrusion 462 on the first side includes a ⅝-inch arbor pilot surface, providing radial constraint for dynamic working tools engaging with the reversible retention flange. The protrusion 472 on the second side includes a ⅜-inch arbor axial clamping surface only, and ⅜-inch arbor pilot surface and radial constraint are directly to the spindle 424 (shown in broken lines) for dynamic working tools with a corresponding arbor size. The axial clamping surfaces 463 and 474 can interface with a dynamic working tool, depending on which side of the reversible retention flange is engaged with the transfer component. For dynamic working tools with a ⅜-inch arbor, the radial interface can, in some cases, occur directly between the dynamic working tool and the ⅜-inch diameter spindle. Together, the step profiles of the protrusions and the axial clamping surfaces contribute to the reversible retention flange's versatility in accommodating dynamic working tools with different arbor sizes.

In some embodiments, the reversible retention flange 454 can include multiple surface finishes. For example, as depicted in FIG. 4C, the first side 460 may include a first finish, while the second side 471 may include a second, distinct finish. These finishes may differ in surface texture, coating, or treatment, and can be configured to improve aesthetics or performance characteristics.

The view of FIG. 4C shows example cross-sectional thickness of the reversible retention flange 454, highlighting its structural stability and ability to provide axial and radial support for dynamic working tools. The protrusion 462 on the first side 460 (on the right) serves as a radial interface 481, which engages with an arbor hole of dynamic working tools configured for a first-sized (e.g., ⅝-inch) arbor. On the second side 471, the protrusion 472 provides axial support, while the radial interface 483 for dynamic working tools with a smaller, second-sized (e.g., ⅜-inch) arbor hole is achieved directly through the ⅜-inch diameter spindle 424. In this way, in some cases, the same spindle arbor diameter can be used to accommodate dynamic working tools with different arbor sizes, as the reversible retention flange 454 extends the effective width of the arbor on the first side 460 to support tools requiring the larger (e.g., ⅝-inch) arbor size. Additionally, the axial clamping surfaces 463 and 474 can provide axial support depending on which side of the flange is engaged with the transfer component. This dual-function design enhances the versatility of the reversible retention flange 454, allowing it to support dynamic working tools with varying arbor hole sizes while utilizing the same spindle arbor diameter. It will be appreciated that, in some cases, the reversible retention flange 454 might not use the spindle as the radial interface 483; for example, it might include a different sized protrusion than the first protrusion 462, configured to fit a differently sized dynamic working tool.

### Example Transfer Component

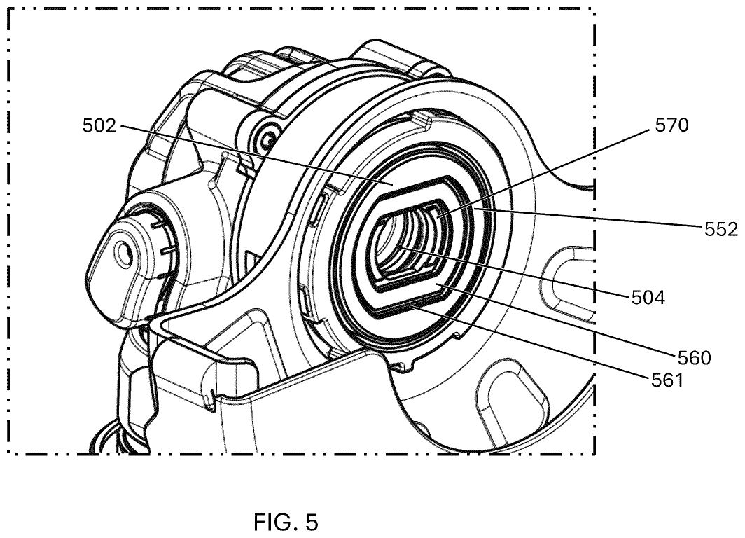

FIG. 5 illustrates a detailed view of the engagement interfaces of the transfer component, in accordance with some embodiments of the present disclosure. The transfer component 552 can be an embodiment of the transfer component 152 of FIG. 2A.

The transfer component 552 includes a body 502 defining a central pass-through aperture 504, which can accommodate an output spindle rotatably driven by an electric motor of the power tool. The central pass-through aperture 504 can be concentrically aligned with a central axis, extending longitudinally through the output spindle.

The transfer component 552 can be engageable with retention flanges of varying sizes, including different sides of a reversible retention flange, such as the reversible retention flange 454 of FIGS. 4A-4C, or separate retention flanges designed for dynamic working tools with differing arbor sizes.

The transfer component 552 can include flat surfaces that engage corresponding flat surfaces on the spindle to rotatably lock the two components together. This engagement can be configured to restrict relative movement while facilitating proper angular alignment during operation. In some configurations, this engagement can reduce the reliance on additional locking mechanisms, as the complementary geometry of the flat surfaces can be sufficient to enable effective torque transfer.

The transfer component 552 can include a first engagement interface 560 that is engageable with a first geometry. The first geometry can include specific structural features, such as protrusions or recesses, that correspond to those of the first engagement interface 560. In some cases, such as shown in FIG. 5, the first engagement interface 560 can be implemented with recessed features. The recessed features can include flat edges 561 or interlocking contours designed to engage corresponding elements of the first geometry. The recessed features can interlock with the mating surfaces of the first geometry to provide engagement and alignment during tool operation. In some cases, the first geometry corresponds to that provided by a retention flange. In this way, a retention flange can engage with the transfer component 552.

The transfer component 552 can include a second engagement interface 570 that is engageable with a second geometry that is different from the first geometry. The second geometry can include specific structural features, such as protrusions or recesses, that correspond to those of the second engagement interface 570. In some cases, such as shown in FIG. 5, the second engagement interface 570 can be implemented with recessed features. For example, the recessed features can include flat edges or interlocking contours designed to engage corresponding elements of the second geometry. The recessed features can interlock with the mating surfaces of the second geometry to provide engagement and alignment during tool operation. In some cases, the second geometry corresponds to that provided by a retention flange. In this way, a retention flange can engage with the transfer component 552.

The second engagement interface 570 of the transfer component 552 can be axially offset from the first engagement interface 560. This axial offset can position the second engagement interface 570 at a different axial location along a central axis of the spindle, compared to the first engagement interface 560. The axial offset allows the transfer component 552 to engage multiple geometries, such as protrusions located on different sides of a reversible retention flange 454. In some cases, the corresponding protrusions that engage the second engagement interface 570 can be deeper than those engaging the first engagement interface 560. This offset enables the transfer component 552 to engage distinct protrusions with different depths, providing secure engagement based on the specific geometry of the retention flange being used.

Consider a scenario in which the reversible retention flange 454, as shown in FIGS. 4A-4C, is used with the transfer component 552. In this case, the first engagement interface 560 of the transfer component 552 can be engageable with the second protrusion 472 on the second side 471 of the reversible retention flange 454. However, the first engagement interface 560 may not be engageable with the first protrusion 462 on the first side 460 of the reversible retention flange 454. Similarly, the second engagement interface 570 of the transfer component 552 can be engageable with the first protrusion 462 on the first side 460 of the reversible retention flange 454, but the second engagement interface 570 may not be engageable with the second protrusion 472 on the second side 471. This configuration allows the transfer component 552 to selectively engage either side of the reversible retention flange 454, depending on the orientation of the reversible retention flange 454 and the specific geometry of the protrusions.

Although the transfer component 552 is shown with only two different engagement interfaces 560, 570 to engage two different geometries, it will be appreciated that the transfer component 552 may include three, four, or more engagement interfaces, each axially offset to engage additional geometries. For example, in some cases, the transfer component 552 can include a third engagement interface axially offset from the first and second engagement interfaces to engage a third protrusion, corresponding to a different retention flange or dynamic working tool geometry. This configuration can allow the transfer component 552 to interact with a wider variety of components, further enhancing the versatility of the power tool by accommodating different geometries and depths.

Although FIG. 5 illustrates the recessed features of the engagement interfaces as being generally aligned in the same direction, with each recess being progressively smaller than the other, it will be appreciated that, in some cases, the recessed features may have differing shapes or configurations. For example, in some embodiments, the recessed features of the engagement interfaces may be rotated relative to each other or may exhibit varying geometries to accommodate differently shaped protrusions or components. This variation in shape and orientation can allow the transfer component 552 to engage with a broader range of geometries, providing further versatility in the types of dynamic working tools or retention flanges that can be utilized with the power tool.

### Example Outer Flange

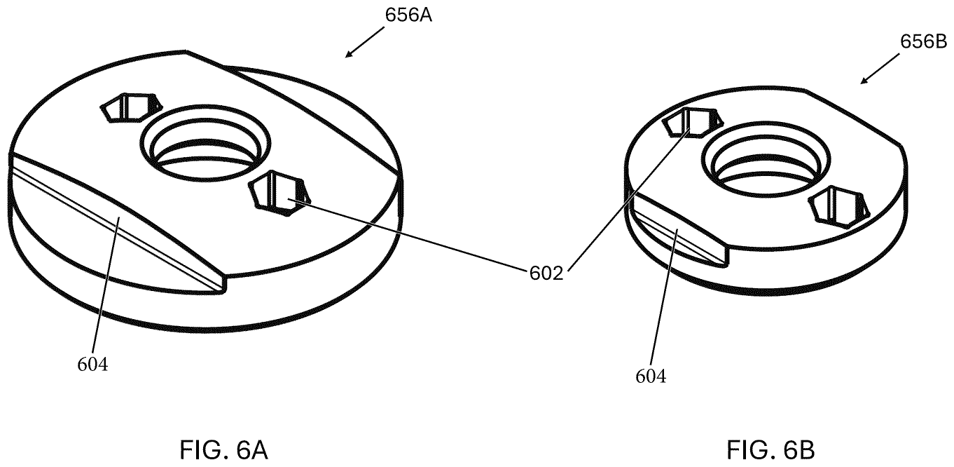

FIGS. 6A and 6B illustrate example outer flanges 656A and 656B, respectively, each designed to secure a tool engagement assembly in place by threading onto the output spindle. The outer flange 656A, as shown in FIG. 6A, and the outer flange 656B, as shown in FIG. 6B, are configured to correspond to different clamping surface diameters and outside diameter required for dynamic working tools of different arbor sizes, allowing for compatibility with the reversible retention flange 654.

The outer flange 656A, depicted in FIG. 6A, is a larger outer flange and can be utilized with dynamic working tools that have larger arbor sizes, such as for use with 4″ accessories that have a Ø⅝″ arbor. The backing flange 656B, depicted in FIG. 6B, is smaller and can correspond to dynamic working tools with smaller arbor sizes, such as for use with 4″ accessories with a Ø⅜″ arbor. Each outer flange 656A, 656B can include recessed features 602 or flat features 604 to engage a wrench for tightening the outer flange to a sufficient torque value. For example, the flat features 604 may be for engagement with a common crescent wrench, and the recessed features 602 may be for engagement with a hex wrench or a spanner wrench.

The outer flanges 656A, 656B of FIGS. 6A and 6B, can each mate with a respective mating side of a reversible retention flange.

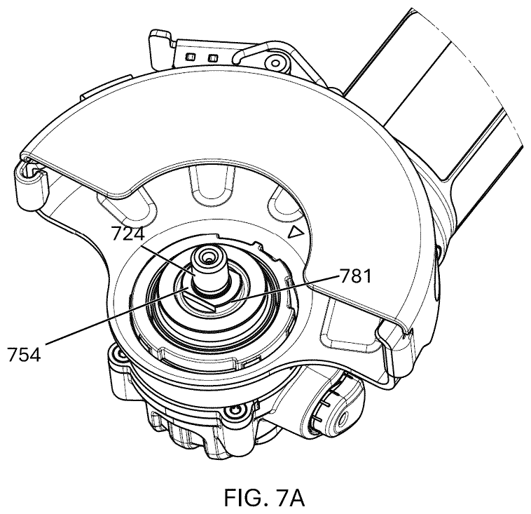

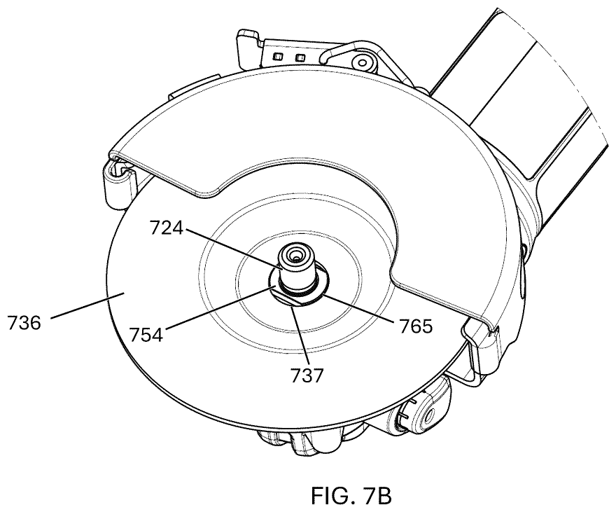

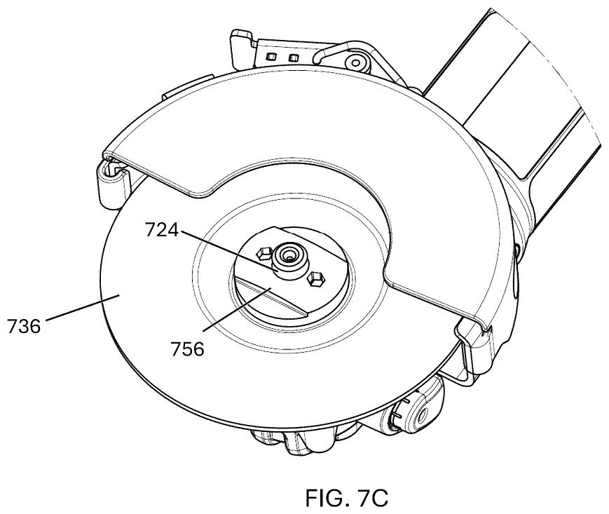

FIGS. 7A-7C illustrate various stages of assembly for a power tool using a first dynamic working tool and the associated retention flanges. FIGS. 7A-7C show an example process of securing a first dynamic working tool 736 between a reversible retention flange 754 and an outer flange 756. FIG. 7A shows a configuration with the reversible retention flange 754 positioned on transfer component (not shown) and about the output spindle 724. The reversible retention flange 754 is mounted onto the transfer component and secured into place, as described herein. FIG. 7B depicts the installation of a first dynamic working tool 736 onto the output spindle 724. The first dynamic working tool 736 is positioned over the reversible retention flange 754 and rests securely between the reversible retention flange 754 and the outer flange (not yet installed in this view). To install the first dynamic working tool 736, the mounting aperture 737 of the first dynamic working tool 736 is aligned with the radial engagement interface 765 and axial engagement interface 463 of the reversible retention flange 754. In this example, the ⅝″ arbor size of the dynamic working tool 736 is significantly larger than the diameter of the spindle 724. To address this disparity and ensure proper radial constraint of the dynamic working tool hub, additional geometry is incorporated into the reversible retention flange 754 to form the radial interface 781. This added geometry compensates for the size difference and securely supports the dynamic working tool during operation. FIG. 7C shows another stage, where the outer flange 756 is installed and threaded onto the output spindle 724 to secure the first dynamic working tool 736 in place.

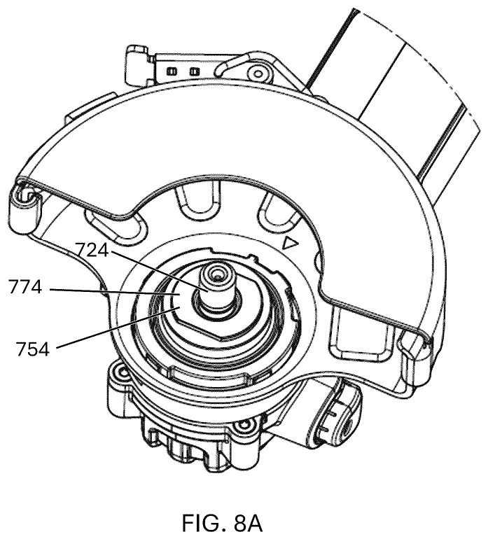

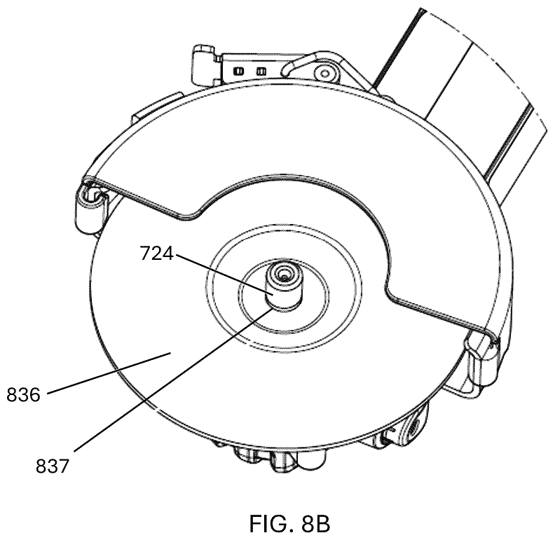

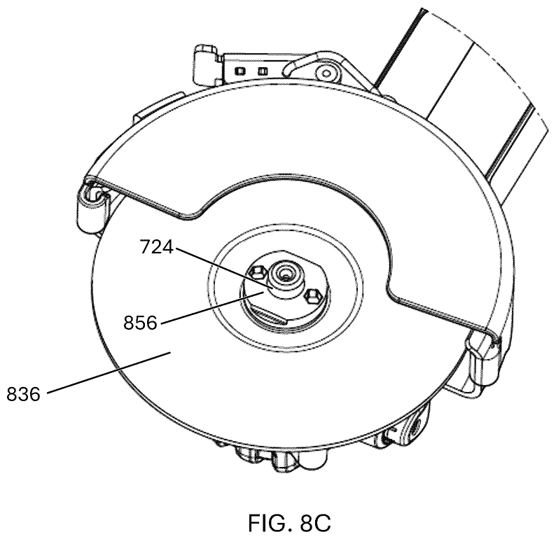

FIGS. 8A-8C are similar to FIGS. 7A-7C but illustrate the reversible retention flange 754 flipped to engage its second side and secured with a smaller outer flange 856. In this configuration, the second engagement interface of the reversible retention flange 754 engages the output spindle 724. To install the second dynamic working tool 836, the mounting aperture 837 of the second dynamic working tool 836 is aligned with the radial engagement interface of the spindle 724 and axial engagement interface 774 of the reversible retention flange. In this example, the ⅜″ arbor size of the dynamic working tool 836 is nearly equal to the diameter of the spindle 724. As a result, the radial constraint of the dynamic working tool 836 is provided directly by the spindle 724, reducing a need for incorporating a radial hub on this side of the reversible retention flange.

### Storage

In some applications, it can be useful to have multiple outer flanges available, but typically only one is needed at a time. For instance, when switching between dynamic working tools with different arbor sizes, the currently unused outer flange can be stored on the tool itself.

FIGS. 9A and 9B illustrate an on-tool storage configuration for a presently unused outer flange. In these figures, a retaining clip 850 engages a designated slot in the tool housing, securing the flange when not in use. In some embodiments, the retaining clip 850 may engage a fastener receptacle (not shown) located on a side wall 22 of the battery receiver 20. The fastener receptacle may be arranged to securely hold a belt clip, a lanyard clip, or other accessories to the side wall 22 of the battery receiver 20. The retaining clip 850 may include includes a generally U-shaped cross-sectional profile sized to securely hold one of the outer flanges 656A or 656B. The retaining clip 850 may include a detent 852 that biasingly engages a threaded mounting aperture of the outer flanges 656A and/or 656B to hold the outer flanges 656A and/or 656B in place. The retaining clip 850 may also hold a wrench 860 adjacent the outer flanges 656A and/or 656B. This design can facilitate convenient storage and quick accessibility, allowing operators to switch between different outer flanges efficiently as needed for different dynamic working tools.

In an alternative embodiment, a retaining post may be utilized in place of the retaining clip 850. The retaining post may include a first threaded stud that is fastened to the fastener receptacle of the side wall 22 of the battery receiver 20, and a second threaded stud that is offset from the first threaded stud and is threaded into the mounting aperture of the one of the outer flanges 656A or 656B.

### Terminology

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “include,” “can include,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Depending on the embodiment, certain operations, acts, events, or functions of any of the routines described elsewhere herein can be performed in a different sequence, can be added, merged, or left out altogether (non-limiting example: not all are necessary for the practice of the algorithms). Moreover, in certain embodiments, operations, acts, functions, or events can be performed concurrently, rather than sequentially.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

Disjunctive language such as the phrase “at least one of X, Y, or Z,” unless specifically stated otherwise, is otherwise understood with the context as used in general to present that an item, term, etc., may be either X, Y, or Z, or any combination thereof (non-limiting examples: X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described elsewhere herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

Any terms generally associated with circles, such as “radius” or “radial” or “diameter” or “circumference” or “circumferential” or any derivatives or similar types of terms are intended to be used to designate any corresponding structure in any type of geometry, not just circular structures. For example, “radial” as applied to another geometric structure should be understood to refer to a direction or distance between a location corresponding to a general geometric center of such structure to a perimeter of such structure; “diameter” as applied to another geometric structure should be understood to refer to a cross sectional width of such structure; and “circumference” as applied to another geometric structure should be understood to refer to a perimeter region. Nothing in this specification or drawings should be interpreted to limit these terms to only circles or circular structures.

1. A reversible retention flange for a power tool comprising:
a body defining a pass-through aperture configured to accommodate an output spindle rotatably driven by an electric motor of the power tool, the body comprising a first face and a second face that is opposite the first face;
wherein the first face of the body defines a first engagement interface, the first engagement interface being geometrically shaped to selectively engage, one at a time:
a first mounting aperture of a first dynamic working tool, wherein the first mounting aperture is of a first size, and wherein radial constraint of the first dynamic working tool engaged with the first face is provided by a hub extending from the first face; and
a transfer component comprising a spindle engagement interface configured to engage the output spindle and rotationally fix the transfer component to the output spindle, wherein engagement between the first engagement interface and the transfer component rotationally fixes the retention flange to the output spindle, and
wherein the second face of the body defines a second engagement interface, the second engagement interface being geometrically shaped to selectively engage, one at a time:
a second mounting aperture of a second dynamic working tool, wherein the second mounting aperture is of a second size, different from the first size, and wherein radial constraint of the second dynamic working tool engaged with the second face is provided directly by the spindle; and
the transfer component, wherein engagement between the second engagement interface and the transfer component rotationally fixes the retention flange to the output spindle.

2. The reversible retention flange of claim 1, wherein the reversible retention flange is not directly mechanically engageable with the output spindle, such that rotational fixation of the reversible retention flange to the output spindle is effected through the engagement between the reversible retention flange and the transfer component.

3. The reversible retention flange of claim 1, wherein the transfer component comprises a first interlocking feature configured to engage with a corresponding geometry on the first engagement interface of the reversible retention flange and a second interlocking feature configured to engage with a corresponding geometry on the second engagement interface of the reversible retention flange, wherein the second interlocking feature is axially offset from the first interlocking feature.

4. The reversible retention flange of claim 1, wherein the transfer component comprises at least two distinct interlocking geometries, each configured to engage a different one of the first engagement interface or the second engagement interface.

5. The reversible retention flange of claim 1, wherein the first and second engagement interfaces include a series of interlocking features configured to engage corresponding interlocking features on the transfer component.

6. The reversible retention flange of claim 1, wherein the first and second engagement interfaces each include a protrusion arranged concentrically around the pass-through aperture, the protrusion being configured to align with mating features on the transfer component.

7. The reversible retention flange of claim 1, wherein the rotational fixation of the first dynamic working tool to the reversible retention flange is facilitated by frictional engagement between axial clamping surfaces of the first engagement interface.

8. The reversible retention flange of claim 1, wherein the first and second engagement interfaces include raised and recessed features configured to align with corresponding features on the transfer component or dynamic working tools, providing rotational fixation and axial stability during operation.

9. The reversible retention flange of claim 1, wherein the first engagement interface is configured to accommodate dynamic working tools with non-circular mounting apertures, and the second engagement interface is configured to accommodate dynamic working tools with circular mounting apertures.

10. A retention flange for a power tool comprising:
a body defining a pass-through aperture configured to accommodate an output spindle rotatably driven by an electric motor of the power tool, the body comprising a first face and a second face that is opposite the first face,
wherein the first face of the body defines an engagement interface, the engagement interface being geometrically shaped to selectively engage, one at a time:
a mounting aperture of a dynamic working tool, wherein engagement between the engagement interface and the mounting aperture rotationally fixes the dynamic working tool to the retention flange; and
a transfer component comprising a spindle engagement interface configured to engage the output spindle and rotationally fix the transfer component to the output spindle, wherein engagement between the engagement interface and the transfer component rotationally fixes the retention flange to the output spindle.

11. The retention flange of claim 10, wherein the engagement interface is a first engagement interface, wherein the dynamic working tool is a first dynamic working tool with the mounting aperture of a first diameter, and wherein the second face of the body defines a second engagement interface being geometrically shaped to engage a second mounting aperture of a second dynamic working tool, wherein the second mounting aperture is of a second diameter, different from the first diameter.

12. The retention flange of claim 10, wherein the second engagement interface is geometrically shaped to engage the transfer component, and wherein the second engagement interface is engageable with the second dynamic working tool or the transfer component, one at a time.

13. The retention flange of claim 10, wherein the power tool is a grinder and the dynamic working tool is a grinding wheel.

14. The retention flange of claim 10, wherein the retention flange is not directly mechanically engageable with the output spindle.

15. A power tool comprising:
a housing;
an electric motor housing within the housing;
an output spindle rotatably driven by the electric motor;
a transfer component having a pass-through aperture through which the output spindle extends and a spindle engagement interface configured to engage the output spindle and rotationally fix the transfer component to the output spindle; and
a reversible retention flange having a through-hole for the output spindle, the flange comprising opposing first and second faces, each with a distinct engagement interface, wherein:
the first face is configured to selectively engage, one at a time, a first dynamic working tool with a first-sized mounting aperture and the transfer component, and
the second face is configured to selectively engage, one at a time, a second dynamic working tool with a second-sized mounting aperture, different from the first, and the transfer component,
whereby the reversible retention flange is operable to accommodate dynamic working tools with a mounting aperture of either the first size or the second size.

16. The power tool of claim 15, wherein the transfer component comprises:
a body defining the pass-through aperture;
a first engagement surface on the body configured to engage the first face of the reversible retention flange; and
a second engagement surface on the body, axially offset from the first engagement surface, configured to engage the second face of the reversible retention flange.

17. The power tool of claim 15, wherein the power tool is a grinder.

18. A transfer component for a power tool comprising:
a body defining a pass-through aperture configured to accommodate an output spindle rotatably driven by an electric motor of the power tool;
a spindle engagement interface disposed on the body and configured to engage the output spindle to rotationally fix the transfer component to the output spindle;
a first engagement surface on the body configured to engage a first retention flange, the first retention flange being configured to engage a first dynamic working tool on a side opposite the engagement with the transfer component; and
a second engagement surface on the body, axially offset from the first engagement surface, configured to engage a second retention flange, the second retention flange being configured to engage a second dynamic working tool on the side opposite the engagement with the transfer component.

19. The transfer component of claim 18, wherein the first retention flange and the second retention flange are part of a reversible retention flange, wherein the first engagement surface is configured to engage a first face of the reversible retention flange, and the second engagement surface is configured to engage a second, opposite face of the reversible retention flange.

20. The transfer component of claim 18, wherein the first face of the reversible retention flange is engageable with a dynamic working tool having a first-sized mounting aperture, and the second face of the reversible retention flange is engageable with a dynamic working tool having a second-sized mounting aperture, different from the first size.
